(19) United States
(12) Patent Application Publication
(10) Pub. No.: US 2025/0245513 A1
(43) Pub. Date: Jul. 31, 2025

(54) Control Unit for Processing a Data Related to a Working Module

(71) Applicants: Robert Bosch GmbH, Stuttgart (DE); Bosch Global Software Technologies Private Limited, Bangalore (IN)

(72) Inventors: Gayathri Dandugula, Anantapur (IN); Sudesh Ganapati Mirashi, Sirsi (IN)

(21) Appl. No.: 19/037,152

(22) Filed: Jan. 25, 2025

(30) Foreign Application Priority Data
Jan. 31, 2024 (IN) 2024 4100 6293

(51) Int. Cl. G06N 3/09; G06N 3/04

(52) U.S. Cl. CPC G06N 3/09; G06N 3/04

(57) ABSTRACT

The control unit receives the data from the working module and collects the received data in a data repository in a predefined format. The control unit then passes the collected data through a predefined set of perceptron layers for processing the collected data. The control unit enhances features extracted from the collected data in at least one start layer of the predefined set of perceptron layers and compress the collected data in at least one end layer of the predefined set of perceptron layer. The control unit then transfers the enhanced and compressed features of the data to a neural network backbone architecture module for applying in a perception application.

This application claims priority under 35 U.S.C. § 119 to application no. IN 2024 4100 6293, filed on Jan. 31, 2024 in India, the disclosure of which is incorporated herein by reference in its entirety.

This disclosure is related to a control unit for processing a data related to a working module.

### BACKGROUND

Deploying neural network model on edge device with limited resources is a great challenge and requires model size to be reduced which in turn reduces its performance on perception applications. Currently in the markets, there are multiple technique available that deals with the feature enhancement performance of neural network on perception applications. But not on increasing the hardware resource requirement which reduces its possibility to deploy it on the edge. Sending original features or compressed features without feature enhancement to the neural network will negatively affect model performance on perception applications.

A patent U.S. Pat. No. 10,582,205 discloses a method for enhancing at least a section of lower-quality visual data using a hierarchical algorithm, the method comprises receiving at least one section of lower-quality visual data; and extracting a subset of features, from the at least one section of lower-quality visual data. A plurality of layers of reduced-dimension visual data from the extracted features are formed and enhanced to form at least one section of higher-quality visual data. The at least one section of higher-quality visual data corresponds to the at least one section of lower-quality visual data received.

### BRIEF DESCRIPTION OF THE DRAWINGS

FIG. 1 illustrates a control unit for processing a data related to a working module in accordance with an embodiment of the disclosure;

FIG. 2 illustrates a flowchart of a method of processing a data related to a working module in accordance with the present disclosure.

### DETAILED DESCRIPTION

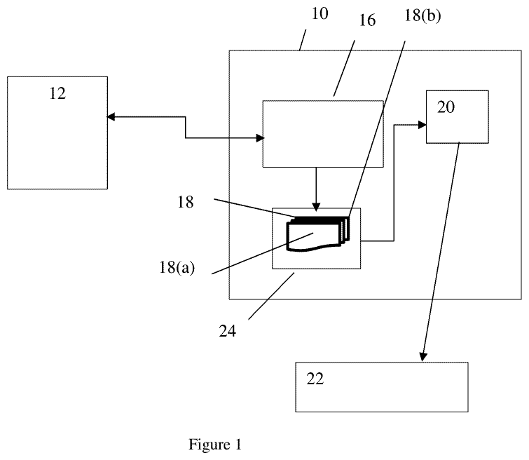

FIG. 1 illustrates a control unit for processing a data related to a working module according to one embodiment of the disclosure. The control unit 10 receives the data from the working module 12 and collects the received data in a data repository 16 in a predefined format. The control unit 10 then passes the collected data through a predefined set of perceptron layers 18 for processing the collected data. The control unit 10 enhances features extracted from the collected data in at least one start layer 18(a) of the predefined set of perceptron layers 18 and compress the collected data in at least one end layer 18(b) of the predefined set of perceptron layer 18. The control unit 10 then transfers the enhanced and compressed features of the data to a neural network backbone architecture module 20 for applying in a perception application 22.

Further the construction of the control unit 10 that is in connection with the working module 12 is explained in detail. The control unit 10 is a logic circuitry and software programs implemented as one or more microprocessors, microcomputers, microcontrollers, digital signal processors, central processing units, state machines, logic circuitries, and/or any component that operates on signals based on operational instructions. The working module 12 is chosen from a group of working modules comprising a radar, an image sensor, a LIDAR, and the like. However, it is to be understood for a person skilled in the art, that the working module is not limited to the above-mentioned modules but can be any other that is used to collect the data. The control unit 10 comprises an enhancement and a compression module 24 for processing the data. The data in the point cloud repository 16 is processed in the pre-processed stage.

The data repository 16 is a point cloud repository and the predefined format in which the data is collected is in a form of M points and N features i.e., the point cloud data is collected with M points with N number of features format, and the point cloud data comprises any one of following a single time frame, a combination/accumulation of multiple time frames. For example, if the working module 12 is an image sensor, the image sensor 12 captures multiple/single image(s) based on the requirement. Each image is referred to as a frame.

The predefined set of perceptron layers 18 comprises an odd number of perceptron layers 18 distributed in an enhancement module and a compression module 24 of the control unit 10. The minimum number of perceptron layers 18 is three and the first and the middle layer 18(a) will perform the enhancement of the features for a better understanding and the last layer 18(b) will do the compression, thus maintaining the hardware size intact. The control unit 10 shares the weights of each of the perceptron layer 18 across the points present in the point cloud repository 16. Each layer 18 is given a vector weight and the value of the weights are maintained such that, the first layer 18(a) will have lesser or equal weight than the consecutive perceptron layer 18 when the enhancement of the features is performed. In addition to that, the weight of the last perceptron layer 18(b) is less than a previous perceptron layer 18, when the compression of the features is performed.

The enhanced and compressed data is transferred to the neural network module present in the control unit 10, such that, thus formed data is used in any one of the perceptron applications 22 like autonomous driving, health care and the like. Due to the enhancement and compression of the collected data in the processing stage, a network model size is reduced.

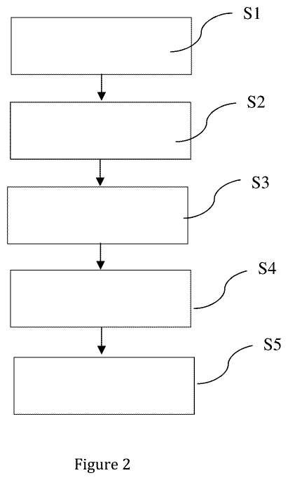

FIG. 2 illustrates a flowchart of a method of processing a data related to a working module in accordance with the present disclosure. In step S1, the data from the working module 12 is received. In step S2, the received data in a data repository 16 in a predefined format is collected. In step S3, the collected data is made to pass through a predefined set of perceptron layers 18 for processing the collected data. In step S4, the features extracted from the collected data is enhanced in at least one start layer 18(a) of the predefined set of perceptron layers 18 and compresses the collected data in at least one end layer 18(b) of the predefined set of perceptron layer 18. In step S5, the enhanced and compressed features of the is transferred data to a neural network backbone architecture module 20 for applying in a perception application 22.

The method of working of the control unit 10 is explained in detail. The working module 12 which is a sensor module according to one exemplary embodiment and wherein for better understanding of the disclosure, the sensor module 12 can be a radar sensor or an image sensor and the perception application is an autonomous driving in a vehicle. The radar/image sensor 12 is mounted on an exterior part of the vehicle and is made to transfer and receive the electromagnetic waves. The radar 12 detects the objects present in the environment by transmitting and receiving the electro magnetic waves. The waves will hit the object present in the surroundings and will reach back to the radar. Wherein in the case of the image sensor 12, multiple images are captured of the surroundings and each image is considered as a single frame for detecting the objects. These are considered as the data that needs to be processed in the control unit 10.

The data repository 16 which is also referred as the point cloud repository receives the object data from the radar module 12. According to one embodiment of the disclosure, the data repository 16 is made as an integral component of the control unit 10, i.e., the data is stored in the memory of the control unit 10. According to another embodiment, the data repository 16 is a cloud repository connected to the control unit 10 via any one of the communication means that is known in the state of the art.

The data received from the radar module 12 is collected in the format of M*N, wherein the M refers to the points and N refers to the features involved in the collected data. The point cloud data is collected with M points with N number of features format, and the point cloud data comprises any one of following a single time frame, a combination/accumulation of multiple time frames. The M*N format is also referred as a predefined format for ease of understanding of the disclosure. Thus, the collected data is made to pass through the enhancement and the compression module 24 of the control unit 10 to obtain an output which is also which is also a point cloud data of M points with Q features.

The compression and enhancement module 24 consists of L number of shared multilayer perceptron layers 18 and the minimum value of L is maintained as an odd number. For example, the minimum value of the L is maintained at three. The weights of the layer 18 are shared across the points in the point cloud repository 16. The predefined set of perceptron layers 18 comprises of three perceptron layers. Out of these three layers, the first layer 18(a) will process N input features to give enhanced features with size O which is made greater or equal to N. The middle layer 18(a) performs further enhancements and outputs features with size P, where P is made greater than O. The last layer 18(b) of the predefined set, will compress the enhanced features coming from middle layer and outputs features with size Q where Q is made less than P. This allows the module 24 to compress the enhanced features hence decreasing hardware resource requirement in neural network backbone module 20 and also size of the network module.

However it is to be understood that, based on the requirement any number of layers 18 can be added in between of the three layers 18 by maintaining the total number of layers to be an odd number. For example, if the enhancement and compression module 24 comprises five layers, then the first, second and the third layers 18(a) will be performing the enhancement of the features extracted from the collected data. These features are related to the objects detected in the surroundings of the vehicle. And the last two layers 18(b), i.e., fourth and fifth layers are used for compressing the data that has the enhanced features, thus maintaining the size of the network module 20.

In addition to this, if the first layer of neural network backbone module 20 outputs features of size R, then Q is made less than or equal to R. Keeping R as close to Q as possible will result in a significant reduction in hardware resource requirement of the neural network. Outputs of neural network backbone module 20 are transferred/used in various perception applications. The perception applications 22 which use this feature compression and enhancement module 24 have a better performance than running without it. These applications 22 also consume less hardware resources as compared to running with prior art enhancement methods.

The disclosure describes the point cloud feature compression and enhancement method, which collects the point cloud data with M points and N number of features and passing them through our feature compression and enhancement module 24. By doing this, the control unit 10 obtains new features of the point cloud data. This helps in understanding and training the module in a better way by enhancing the features in multiple layers. This point cloud with new features could be passed through a neural network backbone structure module 20 whose output could be consumed by several perception applications 22. The presence of our feature compression and enhancement module 24 significantly reduces the hardware resource requirement of the neural network model 20 while improving the performance of perception applications 22 due to the feature enhancement.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit for processing a data related to a working module, the control unit being configured to:
receive data from said working module;
collect said received data in a data repository in a predefined format;
pass said collected data through a predefined set of perceptron layers for processing said collected data;
enhance features extracted from said collected data in at least one start layer of said predefined set of perceptron layers and compress said collected data in at least one end layer of said predefined set of perceptron layer; and
transfer said enhanced and compressed features of said data to a neural network backbone architecture module for applying in a perception application.

2. The control unit as claimed in claim 1, wherein said working module is a sensor chosen from a group of sensors comprising a radar, a camera, and a lidar.

3. The control unit as claimed in claim 1, wherein said data repository is a point cloud repository and said predefined format in which said data is collected is in a form of M points and N features.

4. The control unit as claimed in claim 3, wherein said point cloud data is collected with M points with N number of features format, and the point cloud data comprises any one of following: a single time frame, and a combination/accumulation of multiple time frames.

5. The control unit as claimed in claim 1, wherein said predefined set of perceptron layers comprises an odd number of perceptron layers distributed in an enhancement and a compression module of said control unit.

6. The control unit as claimed in claim 5, wherein weights of each said perceptron layer is shared across the points present in the point cloud repository.

7. The control unit as claimed in claim 6, wherein said weight of first perceptron layer is less than or equal to a weight of a consecutive perceptron layer when said enhancement of said features is performed.

8. The control unit as claimed in claim 7, wherein the weight of the last perceptron layer is less than a previous perceptron layer when said compression of said features is performed.

9. The control unit as claimed in claim 1, wherein due to said enhancement and compression of said collected data in a pre-processing stage, a network model size is reduced.

10. A method of processing a data related to a working module by a control unit, comprising:
receiving data from said working module;
collecting said received data in a data repository in a predefined format;
passing said collected data through a predefined set of perceptron layers for processing said collected data;
enhancing features extracted from said collected data in at least one start layer of said predefined set of perceptron layers and compress said collected data in at least one end layer of said predefined set of perceptron layer; and
transferring said enhanced and compressed features of said data to a neural network backbone architecture module for applying in a perception application.
